(19) United States
(12) Patent Application Publication
(10) Pub. No.: US 2012/0162851 A1
(43) Pub. Date: Jun. 28, 2012

(54) STATIC ELIMINATOR

(76) Inventor: Yoshiaki Sato, Fujisawa-Shi (JP)

(21) Appl. No.: 13/393,573

(22) PCT Filed: Sep. 1, 2010
(86) PCT No.: PCT/US2010/047441

§ 371 Date: Mar. 1, 2012

(30) Foreign Application Priority Data
Sep. 9, 2009 (JP) 2009-208015

(51) Int. Cl. H05F 3/06

(52) U.S. Cl. 361/231

(57) ABSTRACT

A static eliminator that can adjust the balance in the quantities of positive and negative ions reaching a charged object. A static eliminator (1) includes: a first electrode (5) which is disposed inside a housing (2) having at least one open end (2a) and is connected to a positive terminal of a power supply (3); a second electrode (4) which is disposed inside the housing (2) by being spaced a prescribed distance away from the first electrode (5) and is connected to a negative terminal of the power supply (3); and an air provider (6) for producing a stream of air by which the positive ions emitted from the first electrode (5) and the negative ions emitted from the second electrode (4) are delivered to a charged object. At least one of the first and second electrodes (4) and (5) is disposed in such a manner one electrode is linearly movable relative to the other electrode in at least one of forward and backward directions along a direction in which the stream of air flows.

### TECHNICAL FIELD

The present invention relates to a static eliminator for neutralizing static charges present on an electronic component or the like.

### BACKGROUND

Static eliminators have long been used to eliminate static charges present on a charged object by generating positive and negative ions and by supplying the positive and negative ions to the charged object. Such a static eliminator electrically neutralizes static charges on the charged object by blowing air containing the positive and negative ions over the charged object. The better balanced the positive and negative ions generated by the static eliminator, the lower the voltage of the charged object discharged by the static eliminator, that is, the offset voltage, can be made. Here, the offset voltage refers to the voltage of an ion monitor plate discharged by the static eliminator, as measured by a method defined in ANSI (American National Standards Institute)-EOS (Electrical Overstress)/ESD (Electric Static Discharge)-S3.1-2000.

In view of the above, a static eliminator has been developed that can adjust the quantities of the positive and negative ions to be generated (for example, refer to patent document 1 or 2).

### PRIOR ART DOCUMENTS

[Patent document 1] Japanese Unexamined Patent Publication No. H05-114496
[Patent document 2] Japanese Unexamined Patent Publication No. 2006-228681

### SUMMARY

As one method for adjusting the balance of the positive and negative ions to be generated by the static eliminator, there is proposed a method that varies the voltage to be applied to the electrodes. This method generally uses a voltage adjustable power supply. However, such a power supply is costly, and there is therefore a need for a static eliminator that can adjust the ion balance by a less costly method.

In another proposed method, an ion generating device having a face for generating positive ions and a face for generating negative ions is mounted in such a manner that its angle can be varied with respect to the direction of air flow. With this method, however, the distribution of the ions contained in the air flowing from the static eliminator may vary because of the rotation of the ion generating device. That is, a region containing unequal numbers of positive and negative ions may occur in a localized manner in the distribution of the positive and negative ions in a plane perpendicular to the flow direction of the ion-carrying air. Such an unbalanced distribution of ions may defeat the purpose of the static eliminator, and may end up locally charging the object whose static charges are to be removed by the static eliminator.

In view of the above situation, it is an object of the present invention to provide a static eliminator that can adjust the balance in the quantities of the positive and negative ions reaching the charged object, and that can reduce the imbalance of the positive and negative ions.

According to one aspect of the present invention, there is provided a static eliminator. The static eliminator includes: a power supply; a housing having at least one open end; a first electrode which is disposed inside the housing and is connected to a positive terminal of the power supply, and which emits positive ions when power is supplied from the power supply; a second electrode which is disposed inside the housing by being spaced a prescribed distance away from the first electrode and is connected to a negative terminal of the power supply, and which emits negative ions when power is supplied from the power supply; and an air provider for producing a stream of air by which the positive ions emitted from the first electrode and the negative ions emitted from the second electrode are delivered to a charged object. Here, at least one of the first and second electrodes is disposed inside the housing in such a manner that the tip of the one electrode is linearly movable relative to the tip of the other electrode in at least one of forward and backward directions along a direction in which the stream of air flows.

According to another aspect of the present invention, there is provided a static eliminator. The static eliminator includes: a power supply; a housing having at least one open end; a first electrode which is disposed inside the housing and is connected to a positive terminal of the power supply, and which emits positive ions when power is supplied from the power supply; a second electrode which is disposed inside the housing by being spaced a prescribed distance away from the first electrode and is connected to a negative terminal of the power supply, and which emits negative ions when power is supplied from the power supply; and an air provider for producing a stream of air by which the positive ions emitted from the first electrode and the negative ions emitted from the second electrode are delivered to a charged object. Here, at least one of the first and second electrodes is disposed inside the housing in such a manner that the tip of the one electrode is movable relative to the tip of the other electrode in at least one of forward and backward directions along a direction in which the stream of air flows, and that the tip of the one electrode is rotatable in a plane substantially parallel to the direction in which the stream of air flows.

According to the present invention, it becomes possible to provide a static eliminator that can adjust the balance in the quantities of the positive and negative ions reaching the charged object, and that can reduce the imbalance of the positive and negative ions.

### BRIEF DESCRIPTION OF THE DRAWINGS

FIG. 1 is a diagram schematically showing the construction of a static eliminator according to one embodiment of the present invention.

FIG. 2 is a diagram schematically showing the setup of a test system for demonstrating how the static eliminator shown in FIG. 1 can adjust the balance of ions reaching a charged object.

FIG. 3 is a diagram schematically showing the setup of a test system for measuring the balance of the ions reaching the charged object when the orientation of the longitudinal axes of electrodes is changed.

FIG. 4 is a diagram schematically showing the construction of a static eliminator according to another embodiment of the present invention.

FIG. 5 is a diagram schematically showing the setup of a test system for demonstrating how the static eliminator shown in FIG. 4 can adjust the balance of ions reaching a charged object.

### DETAILED DESCRIPTION

Embodiments of the present invention will be described below with reference to the drawings.

A static eliminator according to one embodiment of the present invention includes two electrodes spaced a prescribed distance apart from each other, the construction being such that the ions emitted from the two electrodes with a high voltage applied across them are blown toward a charged object by means of a fan. In this static eliminator, the balance in the quantities of the positive and negative ions reaching the charged object is adjusted by moving at least one of the two electrodes in such a manner that the tip of the one electrode is brought closer to the charged object than is the tip of the other electrode.

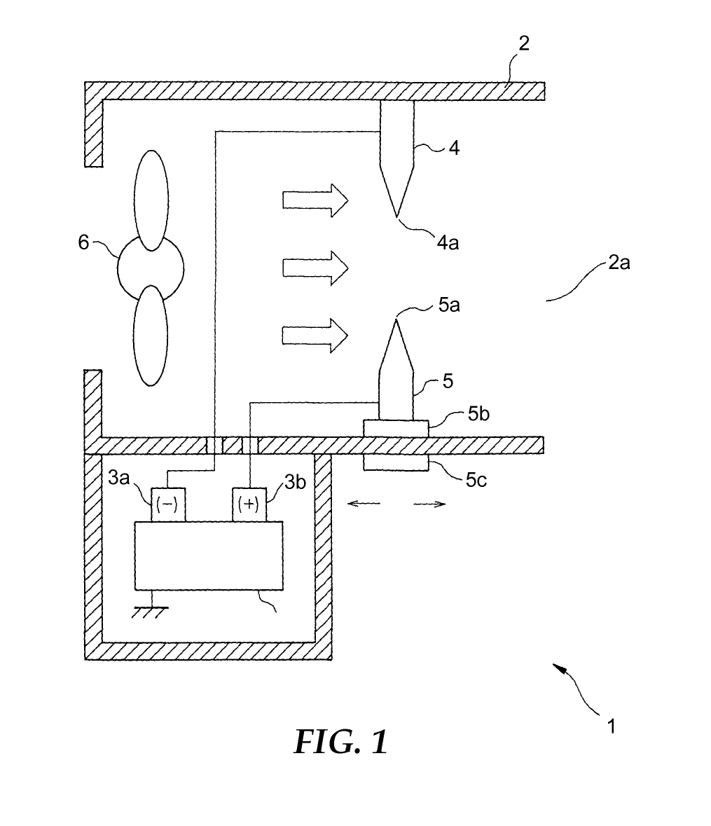

FIG. 1 is a diagram schematically showing the construction of the static eliminator 1 according to the one embodiment of the present invention. As shown in FIG. 1, the static eliminator 1 includes a housing 2, a power supply 3, electrodes 4 and 5, and a fan 6.

The housing 2 is shaped in the form of a hollow cylinder having an opening 2a at one end thereof. The cylindrical portion of the housing 2 provides a passage through which the stream of air produced by the fan 6 passes. The electrodes 4 and 5 and the fan 6 are disposed inside the housing 2.

The power supply 3 supplies a high DC voltage for causing an electric discharge between the electrodes 4 and 5. For that purpose, the power supply 3 includes a booster circuit (not shown) for increasing, for example, the magnitude of the power being supplied from an external power supply to the power supply 3 or from a storage battery built into the power supply 3, and a negative terminal 3a and a positive terminal 3b connected to the booster circuit. Further, the power supply 3 is grounded, and generates a negative potential at the negative terminal 3a with respect to the ground. At the same time, the power supply 3 generates a positive potential at the positive terminal 3b with respect to the ground. That is, the power supply 3 causes a potential difference ranging, for example, from several to several tens of kilovolts to develop between the negative terminal 3a and the positive terminal 3b.

With the DC voltage supplied from the power supply 3, the electrodes 4 and 5 respectively generate negative and positive ions. For that purpose, the electrode 4 is connected to the negative terminal 3a of the power supply 3. On the other hand, the electrode 5 is connected to the positive terminal 3b of the power supply 3.

The electrodes 4 and 5 are each formed from an electrically conductive material molded into a rod-like shape, and pointed tips 4a and 5a are formed at the ends of the respective electrodes. The electrodes 4 and 5 are provided independently of each other and are attached to the housing in such a manner that the tips 4a and 5a of the respective electrodes 4 and 5 face each other with a prescribed spacing maintained between them. Here, an insulating member fixedly attached to the housing, that is, a member fixed thereto independently of the electrodes 4 and 5, for example, a portion of a fan chassis, may be interposed between the electrodes 4 and 5. The electrodes 4 and 5 may be attached to the housing 2 directly or by interposing some kind of supporting member between them. However, it is preferable that the space between the electrodes 4 and 5 is filled with air and/or a fixedly positioned insulating member; that is, it is preferable that a structure, other than the electrodes 4 and 5, that tends to move with the movement of the electrode 4 or 5 is not located between the electrodes 4 and 5. This arrangement serves to prevent the stream of air produced by the fan 6 from varying depending on the position of the electrodes 4 and 5. In this way, the static eliminator 1 can prevent the ions emitted from the electrodes 4 and 5 and discharged through the opening 2a of the housing 2 from being unevenly distributed in an unexpected direction.

It is preferable that the ions are distributed as evenly as possible in the plane perpendicular to the flow direction of the ion-carrying air being delivered from the static eliminator. To achieve this, positive electrodes for emitting positive ions and negative electrodes for emitting negative ions may be disposed in a high-density manner. For example, four positive electrodes and four negative electrodes may be arranged in a radial fashion with their tips pointing toward the center in the plane perpendicular to the flow direction. In the present embodiment, since the tip of the positive or negative electrode moves substantially parallel to the flow direction, the electrode movable range is relatively unaffected if the electrodes are disposed in a high-density manner. Accordingly, even when the electrodes are arranged closely spaced together, the static eliminator of the present invention can achieve a wide ion balance adjusting range.

In another electrode arrangement method, the positive and negative electrodes may be arranged in a grid-like pattern in the plane perpendicular to the flow direction.

The spacing between the tips 4a and 5a of the electrodes 4 and 5 is set so that a discharge (for example, DC corona discharge) occurs at the tips 4a and 5a of the respective electrodes 4 and 5 when voltages from the power supply 3 are applied to the electrodes 4 and 5. For example, in cases where a voltage of −4.0 kV is applied to the electrode 4 and +4.6 kV to the electrode 5, the spacing between the tips 4a and 5a of the electrodes 4 and 5 is typically set within a range of 10 mm to 100 mm. With the discharge occurring at the tips 4a and 5a of the respective electrodes 4 and 5, negative ions are emitted from the electrode 4, while positive ions are emitted from the electrode 5.

The electrode 5 is disposed inside the housing 2 in such a manner as to be movable from a position where its tip 5a is located closer to the fan 6 than the tip 4a of the electrode 4 is to a position where its tip 5a is located closer to the opening 2a of the housing 2 than the tip 4a of the electrode 4 is. In other words, the electrode 5 is disposed inside the housing 2 in such a manner as to be movable along the direction in which the stream of air produced by the fan flows. The direction in which the stream of air produced by the fan flows will hereinafter be referred to as the airstream flow direction. For example, the direction directed from the fan 6 to the opening 2a of the housing 2 along the airstream flow direction is taken as positive (or forward), and the direction directed from the opening 2a of the housing 2 to the fan 6 along the airstream flow direction is taken as negative (or backward). The amount of movement of the electrode 5 is zero when the position of the tip 5a of the electrode 5 coincides with the position of the tip 4a of the electrode 4 when viewed along the airstream flow direction. In the illustrated embodiment, the electrode 5 is disposed so as to be movable within a range of ±20 mm. Here, moving the electrode tip forward is not limited to moving the electrode tip in a direction parallel to the airstream flow direction. Moving the electrode tip forward also includes moving the electrode tip forward in a direction tilted at a predetermined angle relative to the airstream flow direction or moving the electrode tip forward by rotating it in a plane parallel to the airstream flow direction.

The electrode 5 may be disposed inside the housing in such a manner as to be movable in only one direction, either forward or backward relative to the tip 4a of the electrode 4, from the position where the tip 5a is aligned with the tip 4a of the electrode 4.

In the present embodiment, the base of the electrode 5 is inserted in a slit (not shown) which is formed in the housing 2 so as to have a length equal to the movable range of the electrode 5 along a direction substantially parallel to the airstream flow direction. Then, the electrode 5 is fixedly secured to two holding members 5b and 5c which are wider than the slit and provided so as to sandwich the sidewall of the housing 2 from both the inside and outside thereof. This allows the electrode 5 to move along the longitudinal direction of the slit, i.e., along the airstream flow direction.

As the tip 5a of the electrode 5 moves away from the tip 4a of the electrode 4 and comes closer to the opening 2a of the housing 2, the quantity of the positive ions emitted from the electrode 5 and discharged outside the housing 2 through the opening 2a becomes larger than the quantity of the negative ions emitted from the electrode 4 and discharged outside the housing 2 through the opening 2a. Conversely, as the tip 5a of the electrode 5 moves away from the tip 4a of the electrode 4 and comes closer to the fan 6, that is, as the tip 5a moves so as to be located farther away from the opening 2a than the tip 4a is, the quantity of the negative ions emitted from the electrode 4 and discharged outside the housing 2 through the opening 2a becomes larger than the quantity of the positive ions emitted from the electrode 5 and discharged outside the housing 2 through the opening 2a.

In this way, by moving the electrode 5 linearly substantially along the airstream flow direction, the static eliminator 1 can adjust the balance in the quantities of the positive and negative ions to be discharged through the opening 2a. Further, when the electrodes 4 and 5 are arranged in the above manner, the distance between the electrodes 4 and 5 in the plane perpendicular to the airstream flow direction does not change. As a result, in the plane perpendicular to the airstream flow direction, the distribution of the negative and positive ions emitted from the respective electrodes 4 and 5 remains substantially unchanged even when the electrode 5 is moved. That is, the imbalance of the positive and negative ions is minimized despite the movement of the electrode.

Furthermore, since only the electrode 5 and its supporting members are moved inside the housing 2 in order to adjust the ion balance, the disturbance of the air stream, which occurs inside the housing 2 due to the movement of the electrode 5, is held to a minimum. As a result, the static eliminator 1 can prevent the flow direction of the ions to be delivered from the static eliminator from changing when the ion balance is adjusted.

A scale calibrated to indicate the target ion balance in corresponding relationship to the amount of movement of the electrode 5 may be provided on the sidewall of the housing 2 near the position where the electrode 5 is disposed. Then, by referring to the scale, the user moves the electrode 5 to bring the tip 5a of the electrode 5 to the desired position; in this way, the static eliminator 1 can easily deliver the positive and negative ions that match the ion balance intended by the user. Here, the relationship between the position of the electrode 5 and the ion balance is determined in advance, for example, through experiment by variously changing the relationship between the tip of the electrode 4 and the tip of the electrode 5 and by measuring the offset voltage using a charged plate monitor.

The electrode 5 can be disposed inside the housing 2 so as to be movable by a suitable structure. For example, a motor (not shown) may be disposed on the housing 2, and the static eliminator 1 may be constructed so that the electrode 5 is moved by the rotation of the motor. More specifically, a gear may be attached to the end of the rotating shaft of the motor, and the electrode 5 may be attached to a rack that engages with that gear. By disposing the rack on the housing 2 so that it can move in a direction substantially parallel to the airstream flow direction, the electrode 5 can be moved with the rotation of the motor.

The fan 6 produces a stream of air flowing in the direction directed from the fan 6 to the opening 2a of the housing 2 (in FIG. 1, in the direction indicated by the arrows pointing to the right) in order to cause the ions emitted from the electrode 4 or 5 to reach the charged object. Therefore, the fan 6 is disposed in an interior space of the housing 2 opposite from the opening 2a thereof across the electrodes 4 and 5. Further, in order to ensure that the stream of air is discharged through the opening 2a as evenly as possible, it is preferable that the rotating shaft of the fan 6 is aligned with a line extending parallel to the airstream flow direction and passing through the midpoint between the tips 4a and 5a of the respective electrodes 4 and 5 when the electrode 5 is positioned so that the distance from the opening 2a to the tip 5a of the electrode 5 becomes equal to the distance from the opening 2a to the tip 4a of the electrode 4.

Alternatively, the fan 6 may be disposed in a space between the opening 2a and the electrodes 4 and 5. Further alternatively, the fan 6 may be disposed outside the housing 2. In that case, an opening is provided at the opposite end of the housing 2 from the opening 2a. Then, the fan 6 is disposed so that the stream of air produced by the fan 6 is introduced through that opening into the housing 2, passes through the interior of the housing 2, and is discharged through the opening 2a.

The fan 6 may be designed to rotate, for example, at a predetermined speed by being driven by a motor that operates with power supplied from an external power supply or a storage battery built into the static eliminator 1. Alternatively, the power from the external power supply or the storage battery may be supplied to the motor through a variable resistor so that the rotational speed of the fan 6 can be varied.

Further, the static eliminator 1 may be equipped with other air provider instead of the fan 6. For example, the static eliminator 1 may include an air supply port through which compressed air is delivered. The compressed air can be supplied from an air compressor or cylinder located outside the static eliminator 1. The compressed air supply source such as the air compressor or cylinder can be connected to the air supply port by a conduit such as a hose. The air supply port may be provided rearwardly of the electrodes 4 and 5. By delivering the compressed air through such an air supply port, the static eliminator 1 may supply the ions emitted from the electrodes 4 and 5 to the charged object.

Test results for evaluating the static elimination performance of the static eliminator 1 will be shown below.

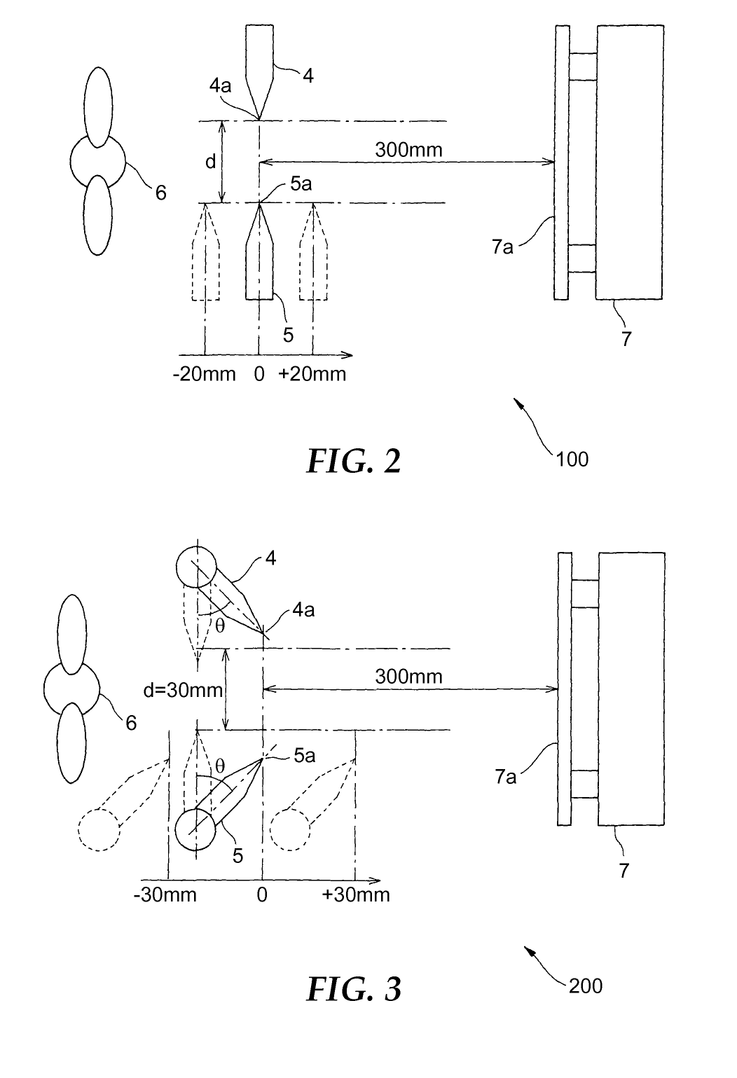

FIG. 2 is a diagram schematically showing the setup of a test system-100 for demonstrating how the static eliminator 1 can adjust the balance of the ions reaching the charged object. In FIG. 2, the component elements of the test system 100 are designated by the same reference numerals as those used to designate the corresponding component elements of the static eliminator 1 shown in FIG. 1.

In the test system 100 shown in FIG. 2, the electrodes 4 and 5 are arranged with their tips 4a and Sa facing each other. The fan 6, which is located to the left of the electrodes 4 and 5, delivers a stream of air from left to right. Each of the electrodes 4 and 5 is formed from tungsten and has a diameter of 1.5 mm, the tip having an angle of 20 degrees, and the protruding length of each electrode, measured from its support base to the tip, is 10 mm. A charged plate monitor 7 (model number 268A, manufactured by MONROE) for observing the balance in the quantities of the positive and negative ions is placed to the right of the electrodes 4 and 5 by being spaced 300 mm away from the tip 4a of the electrode 4 along the airstream flow direction. The charged plate monitor 7 has a charged plate 7a measuring 150 mm×150 mm.

The electrode 5 is movable along the direction in which the stream of air produced by the fan 6 flows. The amount of movement of the electrode 5 is zero when the position of the tip 5a of the electrode 5 coincides with the position of the tip 4a of the electrode 4 when viewed along the airstream flow direction. The amount of movement is taken to be positive when the electrode 5 is moved toward the charged plate monitor 7, and negative when the electrode 5 is moved toward the fan 6.

The test was conducted by applying a voltage of −4.0 kV to the electrode 4 and +4.6 kV to the electrode 5, thus causing the electrode 4 to emit negative ions and the electrode 5 to emit positive ions. Next, while moving the electrode 5 along the airstream flow direction, the ions emitted from the electrodes 4 and 5 were carried from left to right in FIG. 2 by the stream of air produced by the fan 6. Then, the potential at the charged plate 7a was measured.

Table 1 shows the test results obtained when the spacing d between the tips 4a and Sa of the electrodes 4 and 5 was set to 30 mm, 40 mm, 50 mm, 60 mm, 70 mm, and 80 mm, respectively, in the test system 100 shown in FIG. 2. Each entry in Table 1 shows the measured offset voltage value (unit: V).

TABLE 1

| | | ELECTRODE SPACING(mm) | | | | | |
|---|---|---|---|---|---|---|---|
| | | 30 | 40 | 50 | 60 | 70 | 80 |
| AMOUNT OF | 20 | 280 | 180 | 60 | 80 | 50 | 60 |
| MOVEMENT | 10 | 130 | 70 | 0 | 20 | 20 | 20 |
| (mm) | 0 | −60 | −10 | −30 | −30 | −10 | 10 |
| | −10 | −140 | −90 | −90 | −60 | −50 | −20 |
| | −20 | −240 | −180 | −160 | −100 | −70 | −30 |

As can be seen, the static eliminator 1 can adjust the balance in the quantities of the ions reaching the charged object, irrespective of the spacing between the electrodes 4 and 5, by moving the electrode 5 along the air flow direction.

As described above, the static eliminator according to the one embodiment of the present invention is constructed so that, of the two electrodes that emit positive and negative ions, at least one electrode is disposed inside the housing in such a manner that the position of the tip of the one electrode relative to the position of the tip of the other electrode can be changed in a direction substantially parallel to the direction in which the stream of air produced by the fan flows. Accordingly, the static eliminator can adjust the balance in the quantities of the positive and negative ions reaching the charged object, by moving the at least one electrode along the airstream flow direction in such a manner that the tip of one of the electrodes is brought closer to the opening of the housing relative to the tip of the other electrode. Further, the static eliminator need only have a mechanism for moving the electrode tip by hand or by electric means in order to adjust the balance in the quantities of the positive and negative ions reaching the charged object. That is, the static eliminator can be implemented using a simple construction.

Furthermore, in the static eliminator, there is no need to provide, between the fan and the two electrodes or between the two electrodes, a member for adjusting the balance in the quantities of the positive and negative ions reaching the charged object. As a result, since the stream of air produced by the fan is discharged undisturbed through the opening of the housing, the static eliminator can prevent the ions emitted from the two electrodes from being unevenly distributed in an unexpected direction.

The present invention is not limited to the above embodiment. For example, the electrode disposed movably along the airstream flow direction is not limited to the electrode that emits positive ions. In FIG. 1, for example the electrode 4 that emits negative ions may be disposed inside the housing 2 so as to be movable along the airstream flow direction.

In this way, either the positive electrode that emits positive ions or the negative electrode that emits negative ions may be disposed movably, but it is preferable to adjust the ion balance by moving the positive electrode. Generally, if voltages equal in magnitude are applied to the positive and negative electrodes, a larger quantity of negative ions than the quantity of positive ions tends to be emitted. On the other hand, when the positive electrode is moved toward the opening, the quantity of positive ions discharged through the opening of the housing increases. As a result, by moving the positive electrode, the static eliminator can adjust the balance in the quantities of the positive and negative ions without reducing either the quantity of the positive ions or the quantity of the negative ions to be discharged through the opening of the housing.

Alternatively, both of the electrodes 4 and 5 may be disposed inside the housing 2 so as to be movable along the airstream flow direction. When both of the electrodes are disposed movably, the movable range of each electrode necessary to adjust the ion balance can be reduced by one-half compared with the case where only one electrode is movably disposed inside the housing. This serves to reduce the overall size of the static eliminator.

Further, provisions may be made to automatically adjust the electrode position based on a feedback signal supplied from an ion balance monitoring sensor. In this case, the sensor may be attached to the housing 2 or separately provided outside the housing 2.

Furthermore, the two electrodes may be disposed so that their axes lie in the plane perpendicular to the airstream flow direction or are tilted with respect to the plane perpendicular to the airstream flow direction.

FIG. 3 is a diagram schematically showing the setup of a test system 200 for measuring the balance of the ions reaching the charged object when the electrodes are disposed by tilting their axes with respect to the plane perpendicular to the airstream flow direction and when the electrode position is changed in a direction substantially parallel to the airstream flow direction. In FIG. 3, the component elements of the test system 200 are designated by the same reference numerals as those used to designate the corresponding component elements of the test system 100 shown in FIG. 2.

In the test system 200, the electrodes 4 and 5 are disposed with their axes tilted toward the charged plate by an angle θ relative to the plane perpendicular to the airstream flow direction. In this condition, the potential at the charged plate 7a was measured while incrementally changing the angle θ and the position of the electrode 5 along the airstream flow direction. The spacing between the tips 4a and 5a of the electrodes 4 and 5 is 30 mm when the angle θ e is zero, that is, when the tips 4a and 5a of the electrodes 4 and 5 are positioned directly opposite each other.

Table 2 shows the test results obtained when the angle θ was set to 0°, 22.5°, 45°, and 90° (at which the axes of the electrodes 4 and 5 lie parallel to the airstream flow direction), respectively, in the test system 200 shown in FIG. 3. Each entry in Table 2 shows the measured offset voltage value (unit: V).

TABLE 2

| | | ANGLE θ(°) | | | |
|---|---|---|---|---|---|
| | | 0 | 22.5 | 45 | 90 |
| AMOUNT OF | 30 | 400 | 290 | 310 | 270 |
| MOVEMENT | 20 | 270 | 220 | 200 | 130 |
| (mm) | 10 | 150 | 90 | 100 | 40 |
| | 0 | 0 | 0 | 0 | 0 |
| | −10 | −120 | −110 | −130 | −40 |
| | −20 | −180 | −250 | −170 | −100 |
| | −30 | −180 | −390 | −220 | −130 |

| | | | | |
|---|---|---|---|---|
| POSITIVE ELECTRODE | 4.5 | 4.5 | 4.5 | 4.5 |
| POTENTIAL(kV) | | | | |
| NEGATIVE ELECTRODE | −2.94 | −3.36 | −3.31 | −3.05 |
| POTENTIAL(kV) | | | | |

As can be seen, even when the tilt angle of the axes of the electrodes 4 and 5 is changed variously as shown, the static eliminator 1 can adjust the balance in the quantities of the positive and negative ions reaching the charged object, by bringing the tip of one of the electrodes closer to the opening of the housing relative to the tip of the other electrode.

Of the two electrodes, at least one electrode may be disposed inside the housing by various methods, other than the method of the above embodiment, that can change the position of the tip of one ion-emitting electrode relative to the position of the tip of the other ion-emitting electrode along the airstream flow direction.

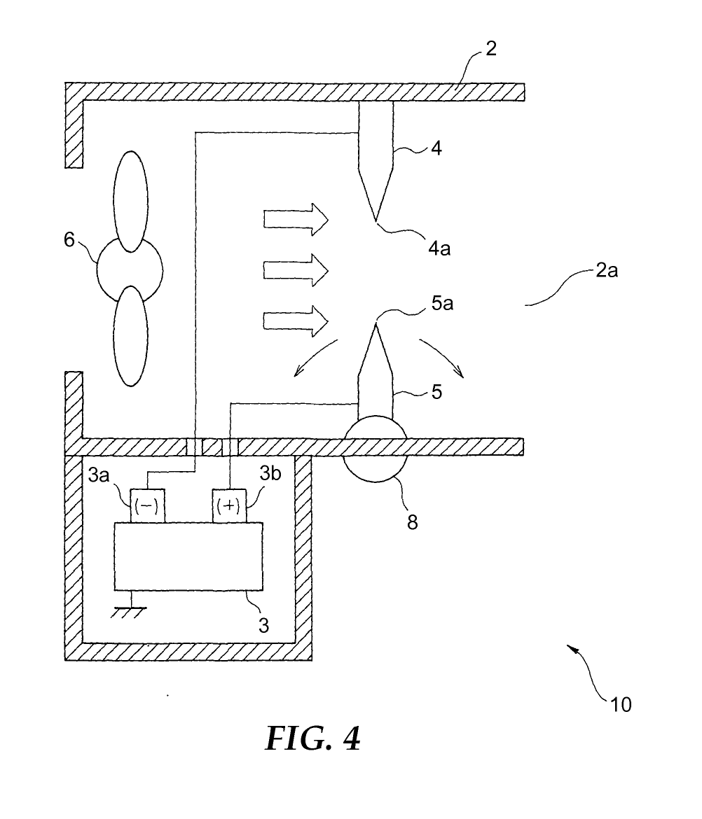

FIG. 4 is a diagram schematically showing the construction of a static eliminator 10 according to another embodiment of the present invention. As shown in FIG. 4, the static eliminator 10 includes a housing 2, a power supply 3, electrodes 4 and 5, and a fan 6. In FIG. 4, the component elements of the static eliminator 10 are designated by the same reference numerals as those used to designate the corresponding component elements of the static eliminator 1 shown in FIG. 1.

The static eliminator 10 differs from the static eliminator 1 in the method of moving the electrode 5. In the static eliminator 10, the base of the electrode 5 is fixedly secured to a supporting member 8. The supporting member 8 is formed, for example, in the shape of a disc, and attached to the housing 2 in such a manner as to be rotatable about the center of the disc in a plane parallel to the airstream flow direction. The electrode 5 is disposed with its axis oriented parallel to the plane in which the electrode rotates. Accordingly, when the supporting member 8 is rotated clockwise, the tip 5a of the electrode 5 also moves clockwise about the center of the supporting member 8. In this case, the tip 5a of the electrode 5 moves closer to the opening 2a of the housing 2 relative to the tip 4a of the electrode 4. That is, the tip 5a of the electrode 5 moves forward along the airstream flow direction. On the other hand, when the supporting member 8 is rotated counterclockwise, the tip 5a of the electrode 5 moves farther away from the opening 2a of the housing 2 relative to the tip 4a of the electrode 4. That is, the tip 5a of the electrode 5 moves backward along the airstream flow direction.

In the present embodiment also, since only the electrode moves when adjusting the ion balance, the stream of air produced by the fan is discharged undisturbed through the opening of the housing, as in the first embodiment. Accordingly, the static eliminator can prevent the ions emitted from the two electrodes from being unevenly distributed in an unexpected direction, and can minimize a locally unbalanced distribution of the positive and negative ions in the plane perpendicular to the airstream flow direction.

In the present embodiment, the distance component defining the distance between the tips of the electrodes 4 and 5 and contained in the plane perpendicular to the airstream flow direction changes with the rotation angle of the electrode. Therefore, from the standpoint of reducing the change of this distance, it is preferable to limit the rotation angle of the electrode to within 45° in each of the forward and backward directions from the plane in which the electrodes 4 and 5 are positioned directly opposite each other. Here, provisions may be made to move the electrode 5 toward the electrode 4 proportionally to the amount of rotation of the electrode 5 in such a manner as to compensate for the amount by which the distance component defining the distance between the tips of the electrodes 4 and 5 and contained in the plane perpendicular to the airstream flow direction changes with the rotation of the electrode.

In one modified example, the electrode 4 may be disposed inside the housing 2 in such a manner as to be rotatable in a plane parallel to the airstream flow direction and containing the electrodes 4 and 5. In this case, the electrode 5 may be disposed so as to be rotatable or so as not to be rotatable.

The electrode may be disposed inside the housing in such a manner that the tip of the electrode is rotatable only forward or backward along the airstream flow direction.

Further, the plurality of electrodes 4 and 5 may be arranged in a radial fashion, as in the first embodiment. The air provider is not limited to the fan, but the static eliminator may include, instead of the fan, an air supply port through which compressed air is delivered.

A scale calibrated to indicate the target ion balance in corresponding relationship to the angle of rotation may be provided on the surface of the supporting member 8 that is exposed outside the housing 2. Then, by referring to the scale, the user rotates the supporting member 8 to bring the tip 5a of the electrode 5 to the desired position; in this way, the static eliminator 10 can easily deliver the positive and negative ions that match the ion balance intended by the user. Here, the relationship between the angle of rotation and the ion balance is determined in advance, for example, through experiment by variously changing the relationship between the tip of the electrode 4 and the tip of the electrode 5 and by measuring the offset voltage using a charged plate monitor.

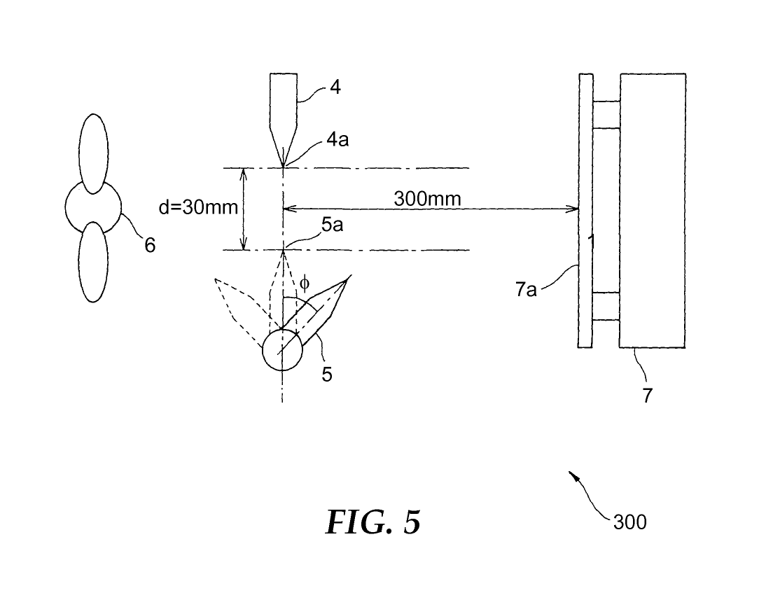

FIG. 5 is a diagram schematically showing the setup of a test system 300 for demonstrating how the static eliminator 10 can adjust the balance of the ions reaching the charged object. In FIG. 5, the component elements of the test system 300 are designated by the same reference numerals as those used to designate the corresponding component elements of the static eliminator 10 shown in FIG. 4. In the test system 300, the charged plate monitor 7 is located 300 mm away from the electrode 4, as in the test system 100.

In the test system 300, the angle that the axis of the electrode 5 makes with the plane perpendicular to the airstream flow direction is designated by θ, and the angle of rotation has a positive value when the tip 5a of the electrode 5 is closer to the charged plate monitor 7 than the tip 4a of the electrode 4 is. In this condition, the potential at the charged plate 7a was measured while incrementally changing the angle of rotation θ. The spacing between the tips 4a and 5a of the electrodes 4 and 5 is 30 mm when the angle θ is 0°.

Table 3 shows the test results obtained when the angle θ was changed within a range of −90° to 90° in the test system 300 shown in FIG. 5. In table 3, a voltage of +4.6 kV was applied to the electrode 5. On the other hand, a voltage of 4.0 kV was applied to the electrode 4.

TABLE 3

| | | OFFSET VOLTAGE(V) |
|---|---|---|
| ANGLE | −90 | −60 |
| OF | −67.5 | −80 |
| ROTATION | −45 | −100 |
| φ(°) | −22.5 | −80 |
| | 0 | 0 |
| | 22.5 | 100 |
| | 45 | 260 |
| | 67.5 | 200 |
| | 90 | 120 |

In this way, the static eliminator 10 can adjust the balance in the quantities of the positive and negative ions reaching the charged object, by rotating one of the two ion-emitting electrodes in such a manner as to bring the tip of the one electrode closer to the opening of the housing relative to the tip of the other electrode.

In each of the embodiments described above, an insulating or conductive guard member formed in a grid-like pattern to prevent humans from touching the electrodes may be attached to the opening of the housing through which the ions emitted from the electrodes are discharged.

As described above, any person skilled in the art can make various changes to match any embodiment to be carried out, without departing from the scope of the present invention.

### DESCRIPTION OF THE REFERENCE NUMERALS

1, 10 STATIC ELIMINATOR
2 HOUSING
2a OPENING
3 POWER SUPPLY
4,5 ELECTRODE
6 FAN
7 CHARGED PLATE MONITOR
7a CHARGED PLATE
8 SUPPORTING MEMBER

1. A static eliminator comprising:
a power supply;
a housing having at least one open end;
a first electrode which is disposed inside said housing and is connected to a positive terminal of said power supply, and which emits positive ions when power is supplied from said power supply;
a second electrode which is disposed inside said housing by being spaced a prescribed distance away from said first electrode and is connected to a negative terminal of said power supply, and which emits negative ions when power is supplied from said power supply; and
an air provider for producing a stream of air by which the positive ions emitted from said first electrode and the negative ions emitted from said second electrode are delivered to a charged object, and wherein
at least one of said first and second electrodes is disposed inside said housing in such a manner that a tip of said one electrode is linearly movable relative to a tip of the other electrode in at least one of forward and backward directions along a direction in which said stream of air flows.

2. A static eliminator comprising:
a power supply;
a housing having at least one open end;
a first electrode which is disposed inside said housing and is connected to a positive terminal of said power supply, and which emits positive ions when power is supplied from said power supply;
a second electrode which is disposed inside said housing by being spaced a prescribed distance away from said first electrode and is connected to a negative terminal of said power supply, and which emits negative ions when power is supplied from said power supply; and
an air provider for producing a stream of air by which the positive ions emitted from said first electrode and the negative ions emitted from said second electrode are delivered to a charged object, and wherein
at least one of said first and second electrodes is disposed inside said housing in such a manner that a tip of said one electrode is movable relative to a tip of the other electrode in at least one of forward and backward directions along a direction in which said stream of air flows, and that the tip of said one electrode is rotatable in a plane substantially parallel to the direction in which said stream of air flows.

3. A static eliminator as claimed in claim 1, wherein a space between said first and second electrodes includes air and/or a fixedly positioned insulating member.

4. A static eliminator as claimed in claim 1, wherein said first electrode is movably disposed inside said housing, and said second electrode is fixedly disposed inside said housing.
